(19) United States
(12) Patent Application Publication
(10) Pub. No.: US 2011/0227925 A1
(43) Pub. Date: Sep. 22, 2011

(54) DISPLAYING A VISUALIZATION OF EVENT INSTANCES AND COMMON EVENT SEQUENCES

(75) Inventors: Wim De Pauw, Scarborough, NY (US); Peter Kenneth Malkin, Ardsley, NY (US)

(73) Assignee: IMB CORPORATION, Yorktown, NY (US)

(21) Appl. No.: 12/724,701

(22) Filed: Mar. 16, 2010

(51) Int. Cl. G06T 11/20; G06F 3/048

(52) U.S. Cl. 345/440; 715/771

(57) ABSTRACT

A method, system and computer readable article of manufacture for displaying visualization from an event log. According to the method, sequences are extracted from the event log. The event log is a record of a plurality of events that occurred. A sequence graph is generated from the sequences. The sequence graph includes nodes representing the events of the event log and the events of each node have a common property. A sequence graph visualization is displayed from the sequence graph. The sequence graph visualization includes (i) node icons representing the nodes of the sequence graph, (ii) node transition icons representing relationships between nodes, and (iii) an event icon for each of the one or more events of a corresponding node.

### BACKGROUND

The present invention relates to a method, system and computer readable article of manufacture for displaying a visualization from an event log. More specifically, the present invention relates to displaying a visualization from an event log showing common sequences and instances of events and transitions between events.

An event is something that has happened in a system, such as an automobile traffic network, a weather system, a manufacturing plant, etc. An event log is a record of events that have occurred. As another example, the development of a complex software or hardware system often benefits from tracing the system to create a log of information about the system's execution, where the execution of each instruction by a processor may be an event; the logs are typically used for debugging and profiling a system. These “event logs” or “trace logs” can become so large that understanding the logs becomes very difficult. Analysis tools may be used to display raw event data. For example, analysis tools can filter events based on their type or show statistics about events.

### SUMMARY OF THE INVENTION

Accordingly, embodiments of the present invention provide a method, system and computer readable article of manufacture for displaying a visualization from an event log showing common patterns and instances of events and transitions.

In particular, an embodiment of the present invention provides a method of displaying a visualization from an event log. According to the method, common event sequences are extracted from the event log. The event log is a record of a plurality of events that occurred. A sequence graph is generated from the sequences. The sequence graph includes nodes representing the events of the event log and the events of each node have a common property. A sequence graph visualization is displayed from the sequence graph. The sequence graph visualization includes (i) node icons representing the nodes of the sequence graph, (ii) node transition icons representing relationships between nodes, and (iii) for at least one of the nodes, an event icon associated with that node for each of the events that are represented by that node.

In another embodiment, the present invention provides a system for displaying a visualization from an event log. A data storage device may store the event log, wherein the event log is a record of a plurality of events that occurred in a system. A sequence extraction processing module may extract sequences from the event log. A sequence graph generating module may generate a sequence graph from the sequences, based on common features of the sequences, wherein the sequence graph includes nodes representing one or more of the events of the event log. A graphing module may create a sequence graph visualization from the sequence graph, wherein the sequence graph visualization includes (i) node icons representing the nodes of the sequence graph, (ii) node transition icons representing transitions between nodes, and (iii) for at least one of the nodes, an event icon associated with that node for each of the one or more events that are represented by that node. A displaying device may display the sequence graph visualization.

In another embodiment, the present invention provides a computer readable article of manufacture tangibly embodying computer readable instructions which when executed causes a computer to carry out the steps of the above method.

### BRIEF DESCRIPTION OF THE DRAWINGS

FIG. 1 is a block diagram of a system for displaying a visualization from an event log according to embodiments of the present invention.

FIG. 2 is a flowchart showing a method for displaying a visualization from an event log according to embodiments of the present invention.

FIG. 3 is a first view of a sequence graph visualization from an event log displayed according to embodiments of the present invention.

FIG. 4 is a second view of a sequence graph visualization from an event log displayed according to embodiments of the present invention.

FIG. 5 is a third view of a sequence graph visualization from an event log displayed according to embodiments of the present invention.

FIG. 6 is another example sequence graph visualization from an event log displayed according to embodiments of the present invention.

FIG. 7 is a user interface for an event log analysis tool with multiple views according to embodiments of the present invention.

FIG. 8 is an example of a hardware and software configuration of a visual system trace analysis tool according to embodiments of the present invention.

### DETAILED DESCRIPTION

Embodiments of the present invention may be used to display a visualization from an event log showing common patterns, instances of events, and transitions between events. A visualization is a visual representation of information or data, such as a diagram that is output to a computer display relating to a system being monitored, to a simulated system, to historical data about events, etc.

An event log is a record of events that occurred in a system. The system may be a software application running on hardware, but is not limited to only software applications. The system may be anything having a logical sequence between events, such as an automobile traffic network, a weather system, a manufacturing plant, etc. For example, in an automobile network, a car passing a particular sensor may be an event, and at a given time 5 cars might be passing sensors on Main Street, in which case these events all have as a feature in common that they occurred on Main Street. In the example of a manufacturing plant, a determination that there is a defect on part of the line may be an event, with the type of event being “defect.” Event logs can become very long and difficult to analyze depending on the size and complexity of the system. The events in event logs typically have common properties (i.e., features) depending on the complexity of the system. The embodiments of the present invention utilize these common features to construct a visualization useful in analyzing event logs.

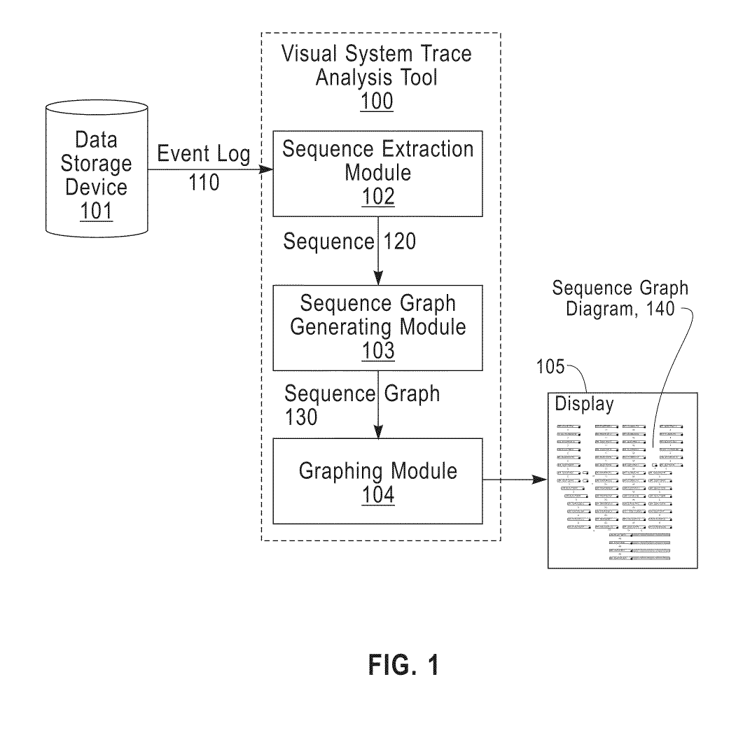

FIG. 1 is a block diagram that shows a system for displaying a visualization from an event log according to embodiments of the present invention. FIG. 1 shows a data storage device 101 that may store an event log 110, a visual trace analysis tool 100, and a display 105. Display 105 may be any type of display device used as an output for a computer system, such as a liquid crystal display (LCD), cathode ray tube (CRT) display, touch screen, etc. The data storage device 101 may be any type of storage device, such a hard drive, tape drive, CD-ROM, etc. The event log 110 stored in data storage device 101 may contain a record for events that occurred in a system. One with regular skill in the art will appreciate that, rather than be stored in an event log, event data could also be fed from a system generating events on the fly and need not be stored. Following is a simplified sample of part of an event log for a trace execution of a software application under test, where each event is the execution of a particular instruction line in the software.

| EVENT | TYPE | PREVIOUS EVENT | NEXT EVENT |
|---|---|---|---|
| 1001 | ADD | 1119 | 1002 |
| 1002 | BRANCH | 1001 | 1150 |
| 1150 | BRANCH | 1002 | 1229 |
| 1229 | STORE | 1150 | 1230 |
| 1230 | BRANCH | 1229 | 1001 |
| 1001 | ADD | 1230 | 1002 |

In this example, event log records the event (e.g., execute instruction 1001), the type of event (e.g., an ADD instruction), the previous event that occurred (e.g., instruction 1119, which preceded this instance of instruction 1001), and the next event to occur (execute instruction 1002). The fields “PREVIOUS EVENT” and “NEXT EVENT” are added for illustrative purposes; the order of events can usually be recovered from the way these events are stored. In another example, the “event” field may include the time stamp for the execution of that instruction to differentiate it from other executions of that instruction. In an alternative embodiment, the event field may include the event type, the software module in which the event was generated, as well as other information related to the event.

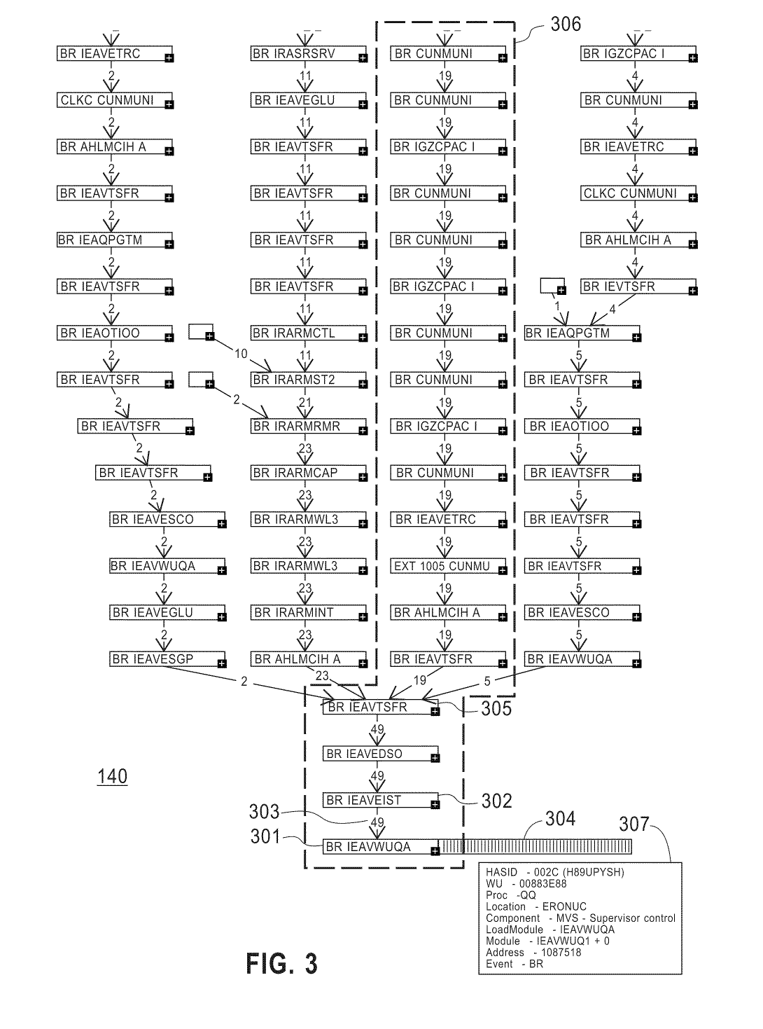

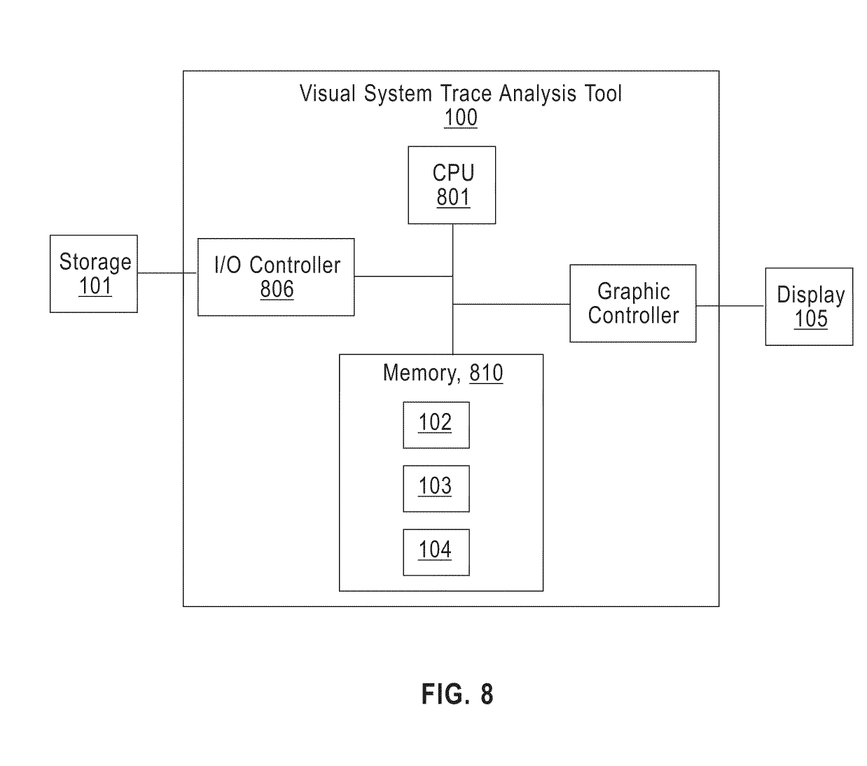

Visual system trace analysis tool 100 is typically embodied as a software application running on a general or special purpose computer system as shown in FIG. 8. In the embodiment shown in FIG. 1, visual system trace analysis tool contains a sequence extraction module 102, sequence graph module 103, and a graphing module 104. In other embodiments, more, less or different modules may be used. A module is a logical software entity. A sequence extraction processing module 102 may extract data representing sequences 120 from the event log 110. A sequence 120 is a number of events connected in a series or thread, wherein each event in the sequence, other than a last event in the sequence, is connected to a next event in the sequence by a relationship. In embodiment, the relationship is a temporal relationship. As used herein, a transition is a relationship between two adjacent events in a sequence. In embodiments, all of the events in a sequence involve the same entity, such an the same sensor in an automobile network, the same weather station, or the same thread of control in a software context. For example, assuming events A and B are part of the same series, and that the relationship of the events in this sequence is one of time order, then event A transitions to event B if event B follows after the completion of event A in temporal ordering in the same thread, if the system executes in threads of control. The sequence data 120 may be extracted by starting at each of the events in an event log 110 and adding the next event in a series until a certain defined maximum. Once the sequences 120 are extracted from the event log, a sequence graph generating module 103 may generate a sequence graph 130 from the sequences 120, based on common features of the sequences. The sequence graph 130 includes nodes representing one or more of the events of the event log 110 that share a common feature. A feature (i.e., property) is a characteristic or attribute of the event. The common feature can be, for example in an embodiment, the event type. A graphing module 104 creates a sequence graph visualization 140 from the sequence graph 130. The sequence graph visualization 140 contains node icons 301, event icons 304, and node transition icons 303 as will be discussed in detail in the description of FIG. 3. As used herein, an icon is a graphic symbol that represents an event, a group of events, or information about an event. Display device 105 may display the sequence graph visualization 140. The sequence extraction processing module 102, the sequence graph generating module 103, and the graph module may all be included in a visual system trace tool 100 that may be executed in a system.

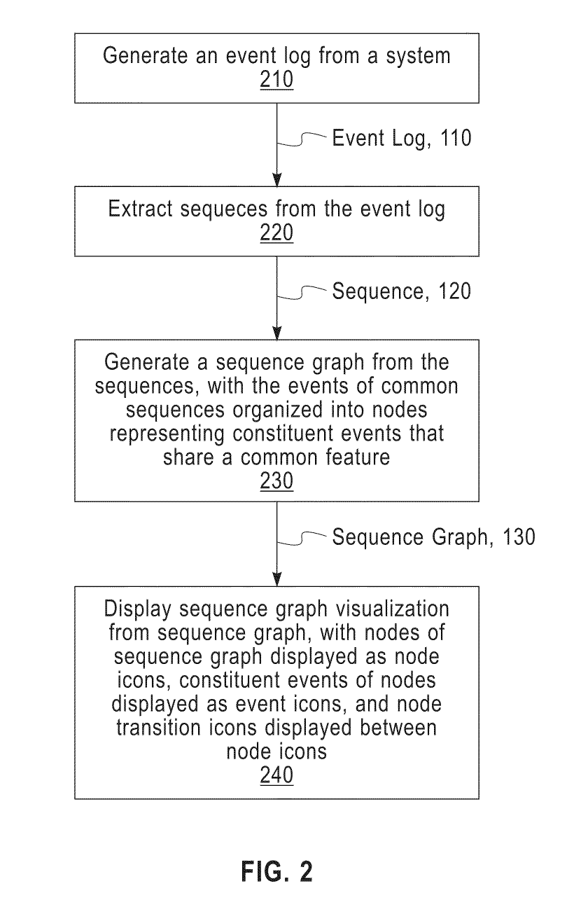

FIG. 2 is a flowchart showing a method for displaying a visualization from an event log according to embodiments of the present invention. An event log 110 may be generated from a system (step 210). For example, the event log may be generated by tracing the execution of a software application under test. In step 220, sequences 120 are extracted from the event log 110. In the software trace example, instruction execution sequences may be identified. Next, a sequence graph 130 is generated from the sequences (step 230). In a sequence graph, the events of common sequences are organized into nodes representing constituent events that share a common feature. A sequence graph visualization 140 is displayed from the sequence graph (step 204), as shown in FIG. 3. In the example of FIG. 3, the nodes of the sequence graph 130 may be displayed as node icons 301. The constituent events of each node are displayed as event icons 304. Node transition icons 303 are displayed between node icons 301, 302 representing transitions between nodes in a common sequence 306.

FIG. 3 is a first view of a sequence graph visualization 140 from an event log 110 displayed according to embodiments of the present invention. The sequence graph visualization 140 includes node icons, for example node icons 301, 302, that represent the nodes of the sequence graph. The node icons 301, 302 may represent constituent events from the event log 110 that share a common feature. The common feature may include any feature of the events recorded in the event log 110. The embodiment as shown in FIG. 3 is a sequence graph visualization of an event log of a trace of software instruction execution and uses the common features of the event type and load module of the event. The node icon 301 represents 49 individual “BR IEAVWUQA” events. In this example, “BR” indicates the event type (e.g., a branch instruction) and “IEAVWUQA” is a truncated indication of the load module of the 49 constituent events. In this example, a load module may be the module the module in the application program that precedes the instruction/event.

The node icons 301, 302 are connected by a node transition icon 303 representing the transitions between nodes represented by the node icons 301, 302. In this example, the node transition icon 303 contains a number reflecting the number of event transitions. Referring to FIG. 3, there are 49 event transitions between node icons 301 and 302. This means that 49 “BR IEAVEJST” events are followed by 49 “BR IEAVWUQA” events (i.e., 49 branch instructions with load module IEAVWUQA). Further, each of the 49 “BR IEAVEJST” events is preceded by a “BR IEAVEDS0” event (301). The node icon 305 labeled “BR IEAVTSFR” is preceded by events that don't share one common feature but instead come from 4 different node icons representing events that each has a common feature. In other words, FIG. 3 is useful in showing that there are 4 common sequences of events to get to the events having the common feature of “BR IEAVWUQA” (305). For example, one of the common sequences of events is shown by the common sequence outlined in the dotted line 306. This allows the developer or user think at a higher abstract level than looking at the individual events.

However, it may be useful for a developer or user to view the individual events from the event log represented by the common sequences 306 shown in the sequence context visualization 140. The event icons 304 represent the constituent events of the node represented by node icon 301. In the example described above, there would be 49 separate event icons 304, each shown as a separate vertical line, because node icon 301 represents 49 separate constituent events. In this example, each event icon 304 represents one instance of the event BR IEAVWUQA. In an embodiment, each event icon is displayed in a manner such that the event icon is shown as associated with the node icon. For example, the event icons 304 may be located within or approximate the node icon 301 in order to show that the event icons 304 represent constituent events of the node represented by the node icon 301. The user may move a pointer over any of the event icons 304 to see details for each event in a tool tip 307. The event icons 304 may be displayed or hidden by expanding or collapsing the node 301. The displaying or hiding of event icons may be controlled by a first and second input from a user. For example, in the embodiment shown in FIG. 3, the event icons 304 are displayed or hidden by selecting a plus or minus sign, respectively, as shown on the node icons 301.

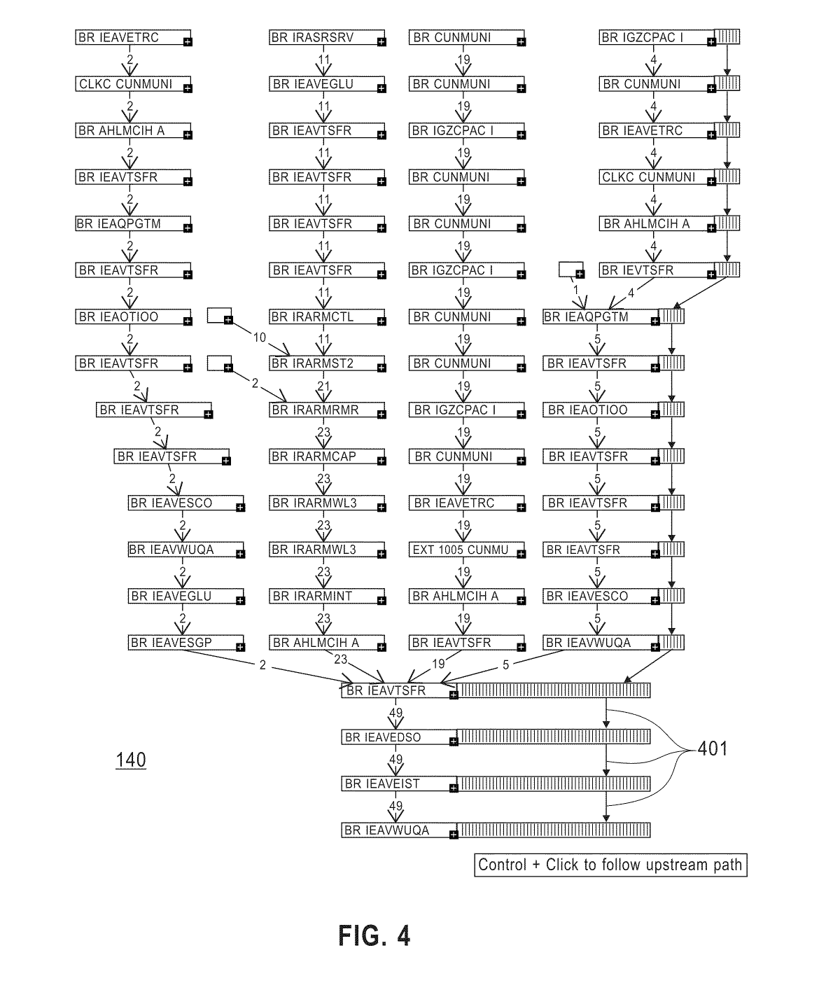

FIG. 4 is a second view of a sequence graph visualization 140 from an event log 110 displayed according to embodiments of the present invention. The sequences of events may viewed by displaying event transition icons 401 between each of the individual events in a sequence. The event transition icons 401 represent transitions between individual events in a sequence of events. In an embodiment, a user may display or hide event transition icons 401 between events by submitting an input. For example, in an embodiment, the user can “control-click” on the top portion of an event icon 304 and an event transition icon 401 will be displayed between the event icon 304 and a predecessor event icon in the sequence of events. The same technique may be used to show the event transition icon 401 to the subsequent event by clicking on the bottom portion of the event icon 304. By further clicking on each event icon 304 the entire sequence of events that led to an event 304 can be displayed as shown in FIG. 4. The event transition icons 401 may also be displayed by “control-clicking” on the top or bottom of the node icons 301, 302 to display all of the event transition icons 401 for each of the constituent events represents by the event icons 304. In yet another embodiment the node icons 301, 302 may be “right-clicked” and an option may be selected from a menu to show all the individual event transition icons 401 corresponding to the ingoing or outgoing event transitions for the events represented by the node icon. In another embodiment the node icon containing the predecessor event will expand to display the constituent events if the node icon wasn't already expanded. In yet another embodiment the node icons containing the preceding or subsequent events are not expanded automatically except under certain conditions such as if they belong to a certain event type.

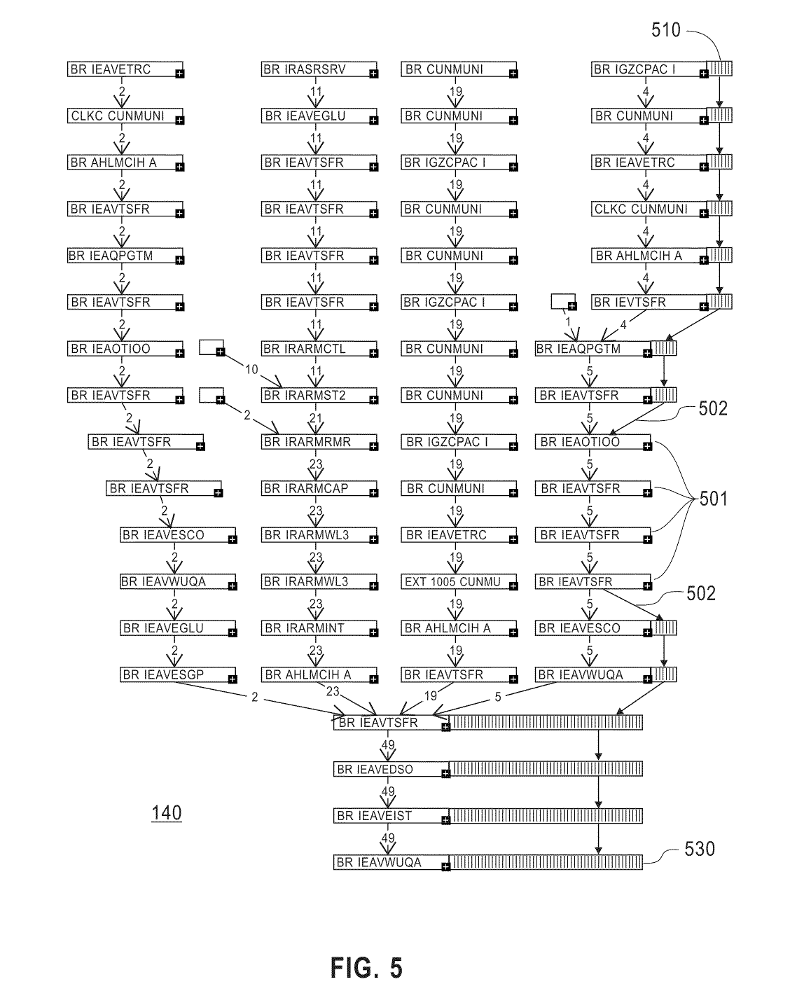

FIG. 5 is a third view of a sequence graph visualization from an event log displayed according to embodiments of the present invention. In this embodiment of the present invention, the node icons 501 may be collapsed so that the event icons 304 are hidden but the transition icons 502 showing a sequence of events will remain visible by connecting directly to the node icons 501 rather than the constituent event icons 304 for those nodes. In this example, the node icons 501 are part of a sequence of node icons from node icon 510 to node icon 530, and all of the node icons in this sequence have their event icons displayed except from the node icons 501

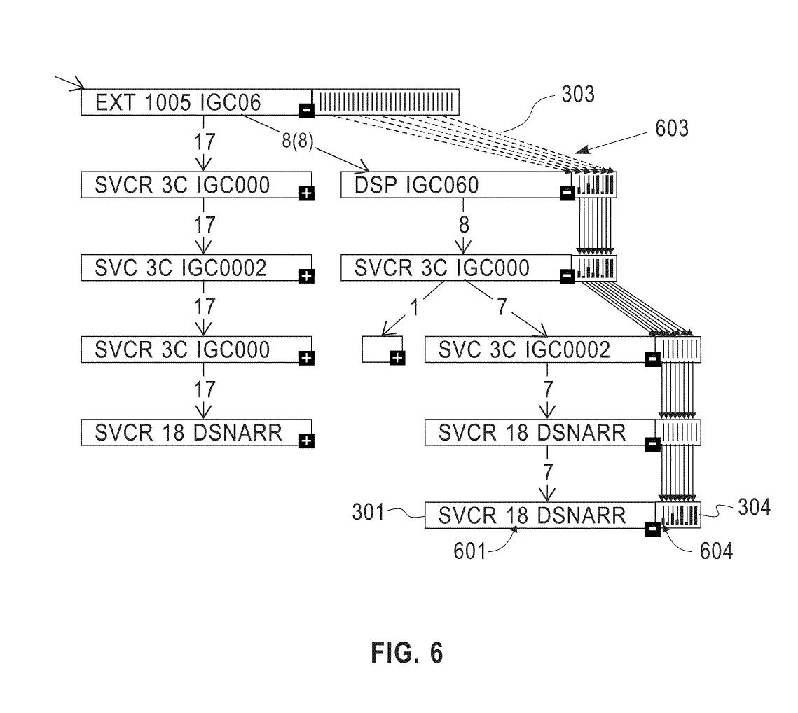

FIG. 6 is another example sequence graph visualization from an event log displayed according to embodiments of the present invention. The event icons 304 may have visual characteristics 604 to represent a magnitude of an event metric. An event metric may be the elapsed time between the call for the event and the next event. The visual characteristic 604 may include any visual indication of magnitude, for example, color, the height of a filled in portion of the event icon, or both. In an embodiment the visual characteristic 604 for the event icons 304 is a dichromatic color scale ranging from black over purple to red, wherein black indicates zero elapsed time and red indicates a maximum elapsed time. In another embodiment the visual characteristic 604 for the event icons 304 is a height of the colored portion of the event icons 304, wherein no colored portion indicates zero elapsed time and a fully colored event icon indicates a maximum elapsed time.

The maximum metric magnitude that corresponds to the maximum visual state of the visual characteristic 604 may also be varied by a user. For example, if the maximum visual state of the visual characteristic 604 is red or a full colored portion of the event icon, then this may be varied to correspond with 10 microseconds of elapsed time or 10 seconds of elapsed time. This allows the user to compare the event metrics of events that are on different orders of magnitude. For example, if the elapsed time for some events was on the order of 1 second and the elapsed time for other events was on the order of 1 microsecond, then it would be hard to compare events that are in a similar range of metric magnitude (e.g. an event with an elapsed time of 5 microseconds and a second event with an elapsed time of 7 microseconds) if the visual characteristic 604 corresponded to the full range from microseconds to seconds.

The node icons 301 may also have a visual characteristic 601 representing the average magnitude of event metrics for each of the constituent events within the node represented by the node icon 301. In a preferred embodiment, the height of the colored portion of the node icon 301 indicates the average magnitude of event metrics for each of its constituent events. In yet another embodiment, other mathematical functions in addition to the average magnitude of event metrics may be used.

The transition icons 303 may have a transition icon characteristic 603 representing a transition property. For example, the transition icon characteristic 603 may be that the transition icon 303 is dotted or dashed. Examples of a transition property include an event thread change or an elapsed time but are not limited to such.

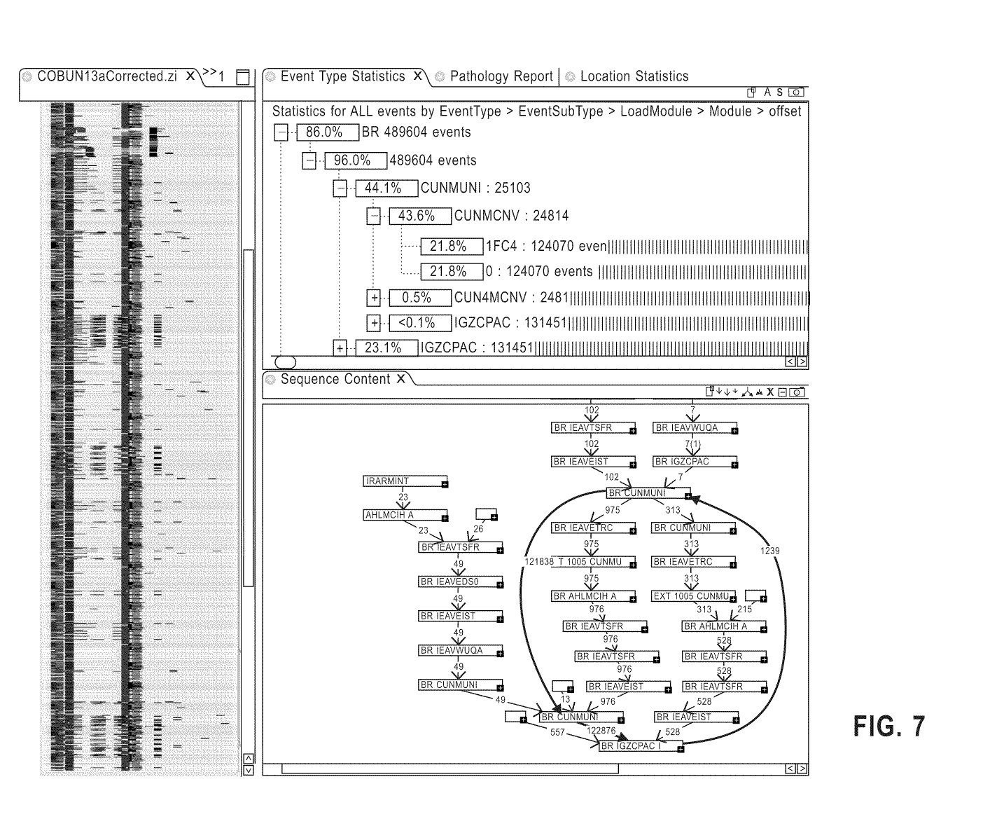

FIG. 7 is a user interface for an event log analysis tool with multiple views according to embodiments of the present invention. In some embodiments, the user interface shown in FIG. 7 may be used as the UI for visual system trace analysis tool 100 discussed above. As shown in FIG. 7, the lower right portion 703 contains the sequence graph visualization 140, as discussed above, according to embodiments of the present invention. Other embodiments of the present invention may include other aspects of the event log analysis tool shown in FIG. 7.

An event flow view 701 shows the events of the event log ordered from top to bottom to show the logical order of events in the trace. In embodiments, each event in the event log is represented by a colored rectangle. The event rectangles may be colored according to their component and positioned horizontally according to the module of the event. The events may be categorized horizontally by address location and process space. Detailed information about the events may be viewed by moving a pointer over an event. A user may also zoom in to regions within the event flow view 701 in order to reveal more details for each event. For example, in the zoomed in view the user can see a white vertical marker within each event rectangle. The horizontal position of the marker relative to the event rectangle indicates which part of the code in the module was executed.

A statistical view 702 may be included to show the events sorted by event type in descending order of frequency. The summary nodes on the left portion of the statistics view 702 each represent a group of events of a certain type. The event icons to the right of each summary node represent the individual events ordered chronologically from left to right. The bars representing individual events in the statistics view 702 may contain a visual characteristic just as the event icons in the sequence graph visualization 703. The visual characteristic, such as color or height, represent elapsed time. The summary nodes can be expanded or collapsed to show or not show the event icons. Further, the summary nodes can be partitions by event type, event subtype, modules, object module, offset, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 8 is an example of a hardware and software configuration of a visual system trace analysis tool 100 according to embodiments of the present invention. In embodiments, visual system trace analysis tool 100 is a trace analysis software application running on a computer hardware platform, such as a personal computer (PC), mainframe computer, personal digital assistant (PDA), etc. The visual system trace analysis tool according to this embodiment includes a CPU 801, a graphic controller 805, and I/O controller 806, and a memory 810. I/O controller 806 may be coupled to and data storage device 101 of FIG. 1, and graphics controller 805 may be coupled to display 805 of FIG. 1. The memory may be any type of computer readable storage medium, as discussed above. The visual system trace analysis tool 100 may contain a communication interface, a hard disk drive, and a CD-ROM drive, which may be coupled to a host controller via an input/output controller, as well as a legacy input/output unit including a ROM, a flexible disk drive, and an input/output chip, which are coupled to the input/output controller.

The CPU 801 may operate on the basis of programs stored in the ROM and RAM so as to control each component. The graphic controller 805 may acquire image data generated by the CPU 801 or the like on a frame buffer provided in the RAM and displays the acquired image data on display unit 105. Alternatively, the graphic controller 805 may include a frame buffer for storing image data generated by the CPU 801 or the like.

A program may be installed into the visual system trace analysis tool 100 and intended to cause it to function as the system for displaying a visualization from an event log shown in FIG. 1. This program operates the CPU 801 and the like in order to cause the system to function as a sequence extraction processing module 102, a sequence graph generating module 103, a graphing module 104, and a displaying device 105, which are shown stored in memory 810.

In other words, when information written in this program is read by the system, the sequence extraction processing module 102, the sequence graph generating module 103, the graphing module 104, and the displaying device 105 are realized as specific means in which software and the above-mentioned various hardware resources collaborate with each other to effect the embodiments of the present invention.

The above-mentioned program or modules may be stored in an external recording medium. Among such recording media are a flexible disk and DVD as well as optical recording media such as a digital versatile disc (DVD) and a compact disc (CD), magneto-optical recording media such as a magneto-optical (MO) disk, tape media, and semiconductor memories such as an IC card. Also, a storage device, such as a hard disk or a random access memory (RAM), provided in a server system connected to a dedicated communication network or the Internet may be used as a recording medium and the above-mentioned program stored in such a storage device may be provided to the system via a network.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of displaying a visualization from an event log, the method comprising the steps of:
extracting a plurality of sequences of events from the event log, wherein the event log is a record of a plurality of events that occurred, and wherein a sequence of events comprises a plurality of events, wherein each event in the sequence, other then a last event in the sequence, is connected to a next event in the sequence by a relationship;
generating a sequence graph from the sequences, wherein the sequence graph comprises nodes, each node representing a plurality of events of the event log, wherein each event represented by a node is from a different sequence, and wherein the events of each node have a common property in addition to said relationship; and
displaying a sequence graph visualization from the sequence graph, wherein the sequence graph visualization comprises (i) node icons representing the nodes of the sequence graph, (ii) node transition icons representing the relationship between events in the nodes, and (iii) for at least one of the nodes, an event icon, associated with that node, for each of the events that are represented by that node.

2. The method of claim 1, wherein said relationship is a temporal relationship.

3. The method of claim 1, wherein all of the events in a sequence involve the same entity.

4. The method of claim 3, wherein the events are the execution of instructions in a computer, and wherein all the events in each sequence are in the same thread of control.

5. The method of claim 1, wherein at least one of the event icons has a visual characteristic representing a magnitude of an event metric, and wherein the visual characteristic of the event icon has a maximum visual state that corresponds to a variable maximum metric magnitude that can be varied by the user.

6. The method of claim 1, wherein at least one of the node icons has a variable visual characteristic representing a magnitude derived from the constituent event magnitudes.

7. The method of claim 6, wherein the variable visual characteristic of the node icon has a maximum visual state that corresponds to a variable maximum metric magnitude that can be varied by the user.

8. The method of claim 1, further comprising displaying an event transition icon between a first and second event icon, wherein the event transition icon represents a relationship between a first event and a second event, and wherein the event transition icon has a transition icon characteristic that represents a property of said relationship.

9. The method of claim 1, further comprising displaying a plurality of transition icons between a plurality of event icons, wherein the plurality of event icons represent a sequence of events.

10. A system for displaying a visualization from an event log, the system comprising:
a data storage device to store the event log, wherein the event log is a record of a plurality of events that occurred in a system;
a sequence extraction processing module to extract a plurality of sequences of events from the event log and transitions to a next event, and wherein a sequence of events comprises a plurality of events connected by one or more transitions;
a sequence graph generating module to generate a sequence graph from the sequences, wherein the sequence graph comprises nodes representing one or more of the events of the event log and wherein the one or more events of each node have a common property; and
a graphing module to create a sequence graph diagram from the sequence graph, wherein the sequence graph visualization comprises (i) node icons representing the nodes of the sequence graph, (ii) node transition icons representing transitions between nodes, and (iii) for at least one of the nodes, an event icon associated with that node for each of the one or more events that are represented by that node.

11. The system of claim 10, wherein the display device displays the event icons associated with the node based on receiving a first input from a user.

12. The system of claim 10, wherein the graphing module hides the event icons associated with the node based on receiving a second input from a user.

13. The system of claim 10, wherein at least one of the event icons has a visual characteristic representing a magnitude of an event metric.

14. The system of claim 13, wherein the visual characteristic of the event icon has a maximum visual state that corresponds to a variable maximum metric magnitude that can be varied by the user.

15. The system of claim 10, wherein at least one of the node icons has a variable visual characteristic representing an average magnitude of the constituent event magnitudes.

16. The system of claim 15, wherein the variable visual characteristic of the node icon has a maximum visual state that corresponds to a variable maximum metric magnitude that can be varied by the user.

17. The system of claim 10, wherein the graphing module creates an event transition icon between a first and second event icon, wherein the event transition icon represents a transition between a first event and a second event.

18. The system of claim 10, wherein the graphing module creates a plurality of transition icons between a plurality of event icons, wherein the plurality of event icons represent a sequence of events.

19. A computer program product for displaying a visualization, the computer program product comprising:
a computer readable storage medium having computer readable program code embodied therewith, the computer readable program code comprising instructions which when executed causes a computer to carry out the following steps:
extracting a plurality of sequences of events from the event log, wherein the event log is a record of a plurality of events that occurred and transitions to a next event, and wherein a sequence of events comprises a plurality of events, wherein each event in the sequence, other then a last event in the sequence, is connected to a next event in the sequence by a relationship;
generating a sequence graph from the sequences, wherein the sequence graph comprises nodes representing one or more of the events of the event log, and wherein the one or more events of each node have a common property in addition to said relationship; and
displaying a sequence graph visualization from the sequence graph, wherein the sequence graph visualization comprises (i) node icons representing the nodes of the sequence graph, (ii) node transition icons representing relationships between events represented by the nodes, and (iii) for at least one of the nodes, an event icon associated with that node for each of the one or more events that are represented by that node.

20. The computer program product of claim 19, wherein said relationship is a temporal relationship, and wherein all of the events in a sequence involve the same entity.

21. The computer program product of claim 19, wherein the event icons associated with a node are displayed based on receiving a first input from a user, and wherein the method further comprises a step of hiding the event icons associated with a node based on receiving a second input from a user.

22. The computer program product of claim 19, wherein all of the events represented by a node are from different sequences.

23. The computer program product of claim 22, wherein the visual characteristic of the event icon has a maximum visual state that corresponds to a variable maximum metric magnitude that can be varied by the user.

24. The computer program product of claim 19, wherein at least one of the node icons has a variable visual characteristic representing a magnitude derived from the constituent event magnitudes.
